(19) United States
(12) Patent Application Publication
(10) Pub. No.: US 2003/0048729 A1
(43) Pub. Date: Mar. 13, 2003

(54) Optical disc of sampled servo format, method for recording information on optical disc, and optical information recording and/or reproducing apparatus

(75) Inventors: Hideki Hayashi, Tsurugashima-shi (JP); Toshio Goto, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/241,712

(22) Filed: Sep. 12, 2002

(30) Foreign Application Priority Data
Sep. 13, 2001 (JP) 2001-278148

(51) Int. Cl. G11B 7/24

(52) U.S. Cl. 369/59.24; 369/275.3

(57) ABSTRACT

An optical disc of a sampled servo format allows a simplifed configuration of an apparatus recording a master disc for optical discs. A method for recording on the optical disc and an optical information recording and/or reproducing apparatus are also disclosed. Onto the optical disc according to the sampled servo method where a synchronization pit and a tracking pit are formed on the same track, data marks that carry information data is recorded between two tracks that are adjacent to each other. Furthermore, when the information data are recorded on and reproduced from such an optical disc, firstly a difference value between read values that are read from the respective tracking pits formed on two tracks adjacent to each other is obtained as a tracking error signal. Next, a position of a beam spot of a laser light projected on a recording surface of the optical disc is controlled according to the tracking error signal, and thereby the beam spot is tracking-controlled so as to trace a portion between the tracks.

### BACKGROUND OF THE INVENTION

1. Field of the Invention

The present invention relates to an optical disc of sampled servo format, a method for recording onto an optical disc and optical information recording and/or reproducing apparatus.

2. Description of Related Art

Sampled servo method is known as one of recording methods that perform high density recording of information data by narrowing a track pitch of an optical disc.

FIG. 1 is a diagram showing an example of conventional pit patterns of an optical disc of sampled servo format. The optical disc of this type is disclosed in detail in “2.2GB Capacity/130 mm Multiplexed Address Sampled Servo Optical Disc”, Technical Digest of Symposium on Optical Memory'94, pp. 53-54(1994).

As shown in FIG. 1, a radial cosine pit Prc, a clock pit Pclk, address pits Padr, and data marks Pdat are formed on each of tracks TRK. The radial cosine pits Prc that are adjacent to each other are provided at positions that are different in a disc's tangential direction. The clock pit Pclk provides a reference phase for a reproduction clock in the recording and/or reproducing apparatus. A mirror face portion between the radial cosine pit Prc and the clock pit Pclk provides a reference for synchronization of the recording and/or reproducing apparatus. The address pits Padr show addresses on a disc surface. The data marks Pdat that carry information data represent the information data by means of their pit intervals and pit lengths. In addition, a pair of wobble pits Pwbl are formed at positions that are displaced from each of the tracks TRK by a predetermined distance. In this arrangement, two adjacent wobble pits provides a reference for a tracking servo in the recording and/or reproducing apparatus, and the two wobble pits overlap with each other in the manner shown in FIG. 1.

In the recording and/or reproducing apparatus, a laser light is projected on an optical disc such as shown in FIG. 1. A beam spot BS is formed on the disc surface, thereby a read signal is obtained based on a reflected light thereof. In such an operation, the recording and/or reproducing apparatus carries out the so-called tracking servo in which the level difference of read signals that are read from two wobble pits Pwbl located on both sides of the track TRK is obtained as a tracking error, and the position of the beam spot BS is controlled so that the tracking error is reduced to zero. Owing to such a tracking servo operation, the beam spot BS is made to trace the track TRK, and thereby the information data is correctly read from the data marks Pdat formed on the track TRK. Thus, in the optical disc shown in FIG. 1, in order to implement the tracking servo, the wobble pits Pwbl are arranged at positions displaced from the track TRK in a disc's radial direction.

In a master disc recording apparatus for recording a master disc of the optical disc shown in FIG. 1, first a recording laser light is projected on the track TRK, thereby forming the radial cosine pit Prc and the clock pit Pclk. Next, this recording laser light is deflected in a disc's radial direction, and the wobble pits Pwbl are formed. Then, the recording laser light is returned onto the track TRK, and the address pits Padr are formed.

Accordingly, in the master disc recording apparatus, in order to form the wobble pits on the master disc, it is necessary to provide the apparatus with a deflector that deflects the recording laser light in a disc's radial direction as mentioned above. As a result, there arises a problem that the master disc recording apparatus becomes complex.

### SUMMARY OF THE INVENTION

The present invention has been made to overcome such problems. It is contemplated by the present invention to provide an optical disc of sampled servo format that is capable of simplifying a configuration of the master disc recording apparatus of the optical discs, a method for recording on the optical disc, and optical information recording and/or reproducing apparatus.

A method for recording on an optical disc in accordance with a sampled servo method according to the present invention is one in which a synchronizing pit for providing a reference for synchronization and a tracking pit for providing a reference for tracking are formed in advance. Both of the synchronizing pit and the tracking pit are formed on the same track of the optical disc, and data marks carrying information data are recorded between two adjacent tracks.

According to another aspect of the invention, an optical disc of sampled servo format according to the present invention is one in which a synchronizing pit for providing a reference for synchronization and a tracking pit for provinding a reference for tracking are formed in advance. Both of the synchronizing pit and the tracking pit are formed on the same track of the optical disc, and data marks that carry information data are recorded between two adjacent tracks.

According to a further aspect of the invention, in an optical information recording and/or reproducing apparatus, recording or reproduction of the information data is performed onto or from an optical disc according to the sampled servo method in which a synchronizing pit for providing a reference for synchronization and a tracking pit for providing a reference for tracking are formed in advance. The optical information recording and/or reproducing apparatus includes: an optical head that projects a laser light between tracks including two tracks that are adjacent to each other in the optical disc, to read the recorded information from the optical disc and obtains read signals, and to write the data marks that carry the information data between the tracks; a component for extracting, from the read signal, a value corresponding to the tracking pit formed on one of the two tracks that are adjacent to each other as a first extracted sample, and a value corresponding to the tracking pit formed on the other track as a second extracted sample; a component for obtaining the difference of the first and second extracted samples as a tracking error signal; and a driving component for controlling a position of irradiation with the laser light according to the tracking error signal so that the laser light traces a portion between two tracks that are adjacent to each other.

### BRIEF DESCRIPTION OF THE DRAWINGS

FIG. 1 is a diagram showing an existing pit pattern of an optical disc according to a sampled servo method;

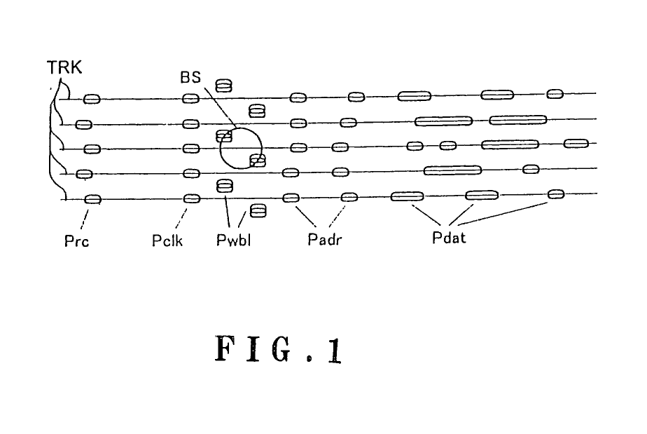

FIG. 2 is a diagram showing a pit pattern of an optical disc of sampled servo format according to the present invention;

FIG. 3 is a diagram showing a pit pattern of a writable or rewritable optical disc at the time of shipping from a factory;

FIG. 4 is a diagram showing a configuration of optical information recording and/or reproducing apparatus according to the present invention;

FIG. 5 is a diagram showing an internal configuration of a tracking error detector 11 shown in FIG. 4;

FIG. 6 is a diagram showing an example of an internal operation waveform of the tracking error detector 11;

FIG. 7A, FIG. 7B, FIG. 8A, FIG. 8B, FIG. 9A and FIG. 9B are diagrams showing an area where a beam spot traces nearby trackig pits on an optical disc according to the present invention and a waveform of a read signal obtained from this area;

FIG. 10 is a diagram showing a pit pattern of an optical disc according to the sampled servo method according to another embodiment of the present invention; FIG. 13B are diagrams respectively showing an area where a beam spot traces nearby tracking pits on an optical disc according to another embodiment of the present invention and a waveform of a read signal obtained from this area.

### DESCRIPTION OF THE PREFFERRED EMBODIMENTS

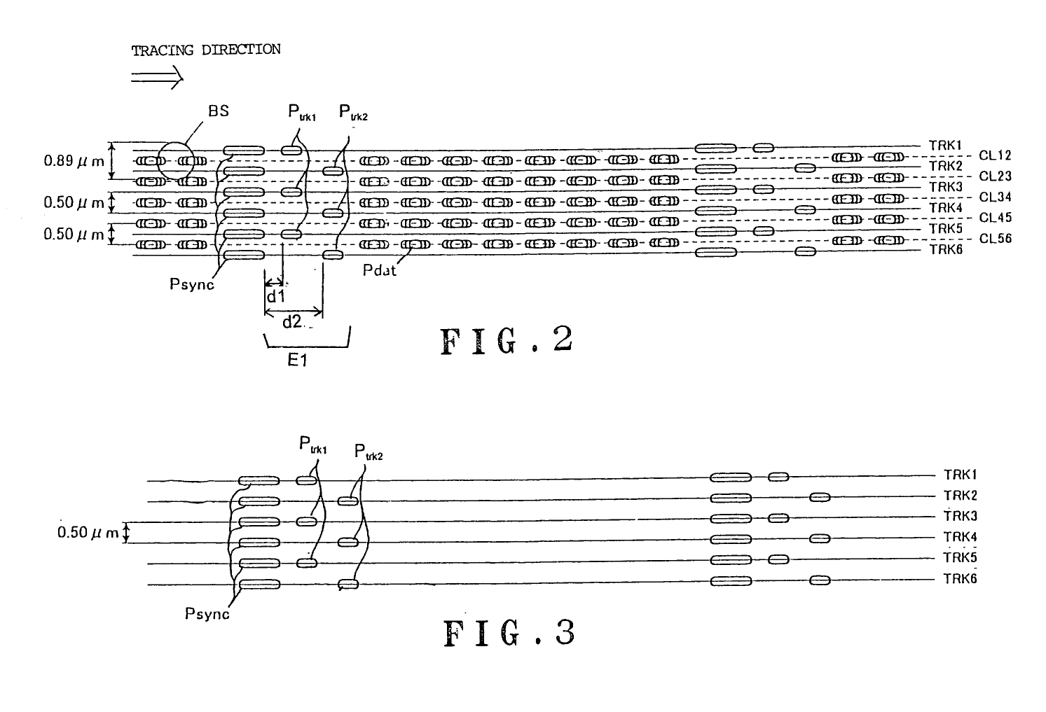

FIG. 2 is a diagram showing a pit pattern of an optical disc according to the present invention having a sampled servo format. In the present embodiment, a phase-change recording type optical disc will be explained as an optical disc, and a phase-change recording layer is deposited on a recording surface.

In FIG. 2, on each of tracks (TRK 1 through TRK 6 in the drawing), a synchronizing pit Psync and a tracking pit Ptrk1 or Ptrk2 are formed in advance. In an embodiment shown in FIG. 2, on each of odd number tracks (TRK1, TRK3 and TRK5) the tracking pit Ptrk1 is formed, and on each of even number tracks (TRK2, TRK4 and TRK6) the tracking pit Ptrk2 is formed.

The synchronizing pits Psync function as a reference for synchronization at the time of recording and/or reproducing, and are aligned in a disc's radial direction with a longer pit length than other pits so that the reproducing apparatus will easily detect these pits. Furthermore, the synchronizing pits Psync provide a reference for a clock phase at the time of recording and/or reproducing. The tracking pits Ptrk1 and Ptrk2 are used in tracking control at the time of recording and/or reproducing. As shown in FIG. 2, the tracking pit Ptrk1 is formed on each of the odd number tracks with a distance d1 separated from the synchronizing pit Psync, and the tracking pit Ptrk2 is formed on each of the even number tracks with a distance d2 separated from the synchronizing pit Psync.

Furthermore, the data marks Pdat that carry the information data are recorded on each of centerlines (CL12, CL23, CL34, CL45 and CL56) shown with dotted lines between the tracks in FIG. 2. The data marks Pdat are recorded with phase change recording according to, for instance, a mark-edge multi-level recording method. In the mark-edge multi-level recording method, at each of edge portions of the data mark Pdat, the information data that takes any of three values, for instance, (0, 1, 2) is recorded. That is, a train of marks with a definite period, in which the edge position changes in three steps according to the information data, is formed on the track. Specifically, when a recording data is “0”, the position of the edge portion is shifted by a definite distance in a direction where the mark length becomes shorter, when the recording data is “1”, the position of the edge portion is unchanged, and when the recording data is “2”, the position of the edge portion is shifted by a definite distance in a direction where the mark, length becomes longer. Thus the information data of three values are recorded as positional information of the edge portion. In FIG. 2, although the positions of three edge portions are shown overlapped, an actual edge portion takes any one of three positions.

Furthermore, a track pitch of the optical disc shown in FIG. 2 is 0.50 μm and 56% with respect to a diameter (0.89 μm) of a beam spot BS that is formed when the laser light is focused on the optical disc. In this case, a distance between centerlines of two tracks on which the data marks Pdat are recorded is also 0.50 μm and a recording density, that is, a track density in a disc radial direction is very high.

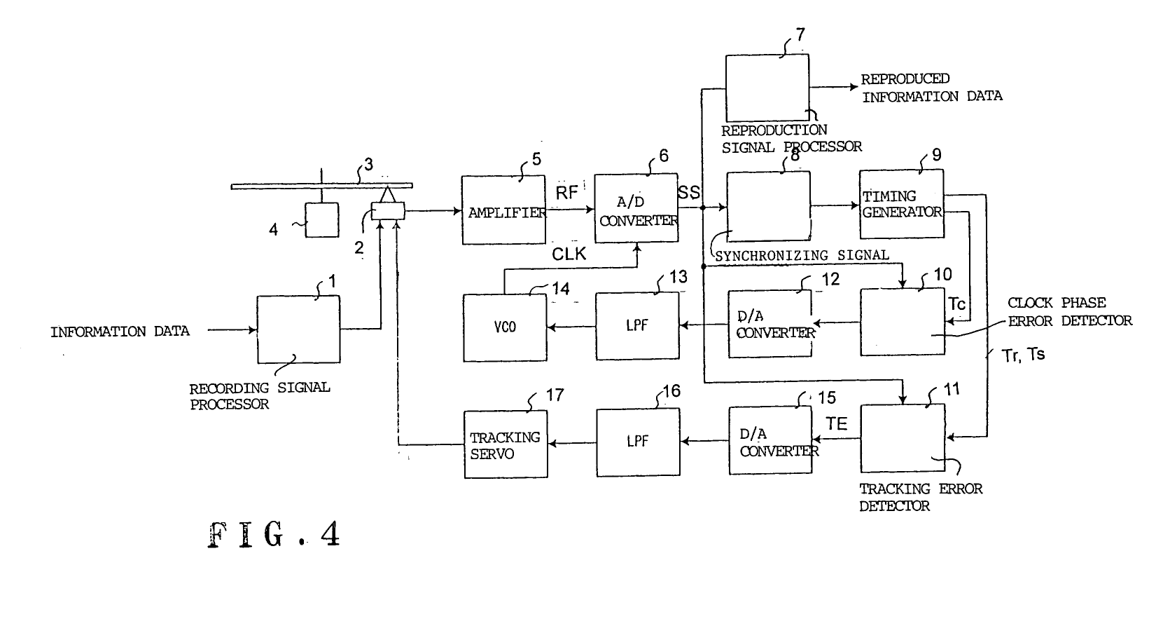

FIG. 2 shows a disc surface where the data marks Pdat that carry the information data have already been recorded. However, if an optical disc is writable or rewritable, the disc is shipped from a factory without recording the data marks Pdat. In this case, a disc surface before recording the data marks Pdat is like that shown in FIG. 3.

Accordingly, in the master disc recording apparatus for recording the master disc of such optical discs, there is not any need of a deflector that deflects the recording laser light in a disc's radial direction since not only the synchronizing pit Psync but also the tracking pit Ptrk for use in tracking control may be formed on the track.

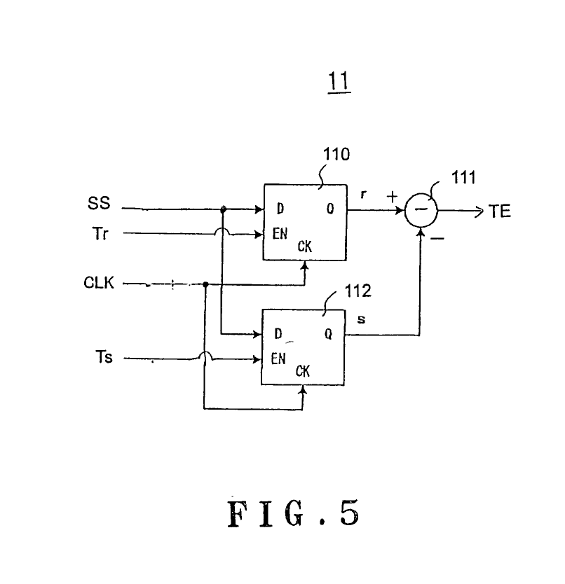

FIG. 4 is a diagram showing a configuration of optical information recording and/or reproducing apparatus in which the information data are recorded onto and reproduced from such an optical disc.

In FIG. 4, a recording signal processor 1 performs a predetermined recording and modulation process onto the information data to be recorded and supplies the obtained recording signal to the optical head 2. The optical head 2 is provided with a light source (not shown in the drawing) that generates a laser light having a wavelength λ of 650 nm, and an object lens (not shown in the drawing) having a numerical aperture NA of 0.6 that focuses and projects the laser light on a recording surface of the optical disc 3. When the laser light is projected by such an optical system, as shown in FIG. 2, the beam spot BS having a diameter of

0.82λ/NA=0.89(μm)

is formed on the recording surface of the optical disc 3.

Furthermore, the optical head 2 is provided with a tracking actuator (not shown in the drawing) that moves an optical axis of the object lens in a disc radial direction, and a light detector (not shown in the drawing) that performs photoelectric conversion of a light reflected from the optical disc 3 and obtains a read signal.

The optical head 2, when the optical information recording and/or reproducing apparatus is in the recording operation, generates a recording laser light of high power intermittently according to the recording signal supplied from the recording signal processor 1 and project it on a recording surface of the optical disc 3 that is rotated by a spindle motor 4. With this arrangement, the data marks Pdat as shown in FIG. 2 are formed on the recording surface of the writable or rewritable optical disc 3. On the other hand, when the optical information recording and/or reproducing apparatus is in the reproduction operation, the optical head 2 projects a low power reading laser light on the recording surface and supplies a read signal corresponding to the reflected light thereof to an amplifier 5. The amplifier 5 amplifies a level of the read signal to a desired level and supplies the obtained amplified read signal to an A/D converter 6 as a read signal RF. The A/D converter 6 samples the read signal RF at the timing synchronized with a reproduction clock signal CLK and outputs an obtained sample sequence as a read sample sequence SS. A reproduction signal processor 7 performs a predetermined demodulation process and a predetermined error correction process onto such a read sample sequence SS, thereby reproducing the information data recorded on the optical disc 3, and outputs this as a reproduced information data.

A synchronizing signal detector 8 outputs a synchronous detection signal upon detecting the sample corresponding to the synchronizing pit Psync from the read sample sequence SS. A timing generator 9 generates a timing signal Tc that shows a timing of each of the front edge portion and rear edge portion of the synchronizing pit Psync based on the synchronous detection signal, and supplies this to a clock phase error detector 10. In addition, the timing generator 9 generates a timing signal Tr that shows a timing of the tracking pit Ptrk1 that is first read after the synchronous detection signal is supplied, and a timing signal Ts that shows a timing of the tracking pit Ptrk2 that is read following the above, and supplies these to the tracking error detector 11. The clock phase error detector 10, based on the above timing signal Tc, extracts the sample corresponding to each of the pit edges on both sides of the synchronizing pits Psync from the read sample sequence SS, and supplies the level difference of both values to a D/A converter 12 as a phase error data. The D/A converter 12 converts such phase error data into an analog signal, and supplies the obtained phase error signal to an LPF (Low Pass Filter) 13. The LPF 13 makes a waveform of the phase error signal smooth and supplies the smoothed signal to a VCO (Voltage Controlled Oscillator) 14. The VCO 14 alters an oscillation frequency of a clock to be generated according to a level of the smoothed phase error signal, thereby generates a clock signal phase-synchronized with the read signal RF, and supplies this to the A/D converter 6 as the reproduction clock signal CLK.

The aforementioned A/D converter 6, clock phase error detector 10, D/A converter 12, LPF 13 and VCO 14 constitute a PLL (Phase Locked Loop). The PLL is a servo-loop for allowing a phase of the reproduction clock to phase-synchronize with the read signal.

The tracking error detector 11 extracts each of the samples that are obtained when a pair of tracking pits Ptrk1 and Ptrk2 as shown in FIG. 2 is read from the read sample sequence SS based on the timing signals Tr and Ts, and outputs the level difference of both values as a tracking error data TE. A D/A converter 15 converts the tracking error data TE to an analog tracking error signal and supplies it to a LPF (Low Pass Filter) 16. The LPF 16 makes a waveform of such tracking error signal smooth and supplies the smoothed one to a tracking servo circuit 17. The tracking servo circuit 17 supplies a tracking servo signal to the optical head 2 so that a tracking actuator mounted on the optical head 2 may be driven by an amount corresponding to the smoothed tracking error signal.

The aforementioned amplifier 5, A/D converter 6, tracking error detector 11, D/A converter 15, LPF 16, tracking servo circuit 17, and optical head 2 constitute the tracking servo loop. A beam spot due to a recording or reading laser light projected from the object lens of the optical head 2, with the tracking servo loop, is subjected to a tracking-control so as to trace a centerline CL between two tracks adjacent to each other on the optical disc 3.

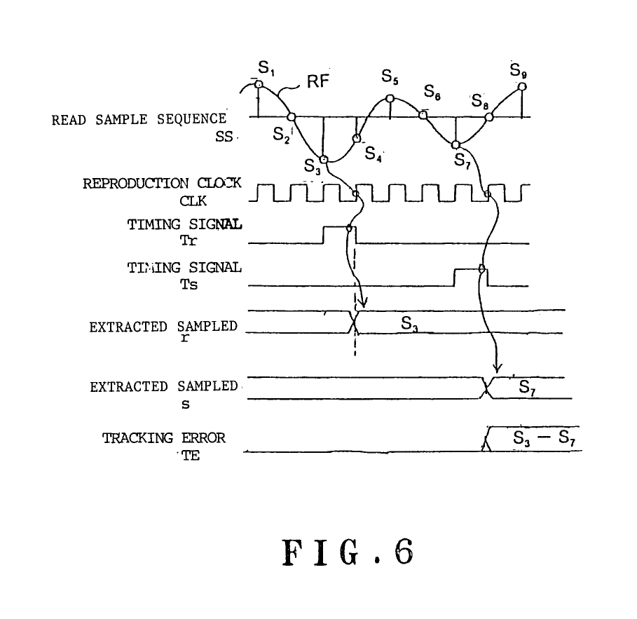

FIG. 5 is a diagram showing an internal configuration of the tracking error detector 11.

In FIG. 5, a D flip-flop 110, as far as the timing signal Tr is a logic level of “1”, fetches the sample in the read sample sequence SS at the timing of the reproduction clock signal CLK, and supplies it to a subtracter 111 as an extracted sample r. A D flip-flop 112, as far as the timing signal Ts is a logic level of “1”, fetches the sample in the read sample sequence SS at the timing of the reproduction clock signal CLK, and supplies it to the subtracter 111 as an extracted sample s. The subtracter 111 outputs a difference value between the extracted samples r and s as the tracking error data TE.

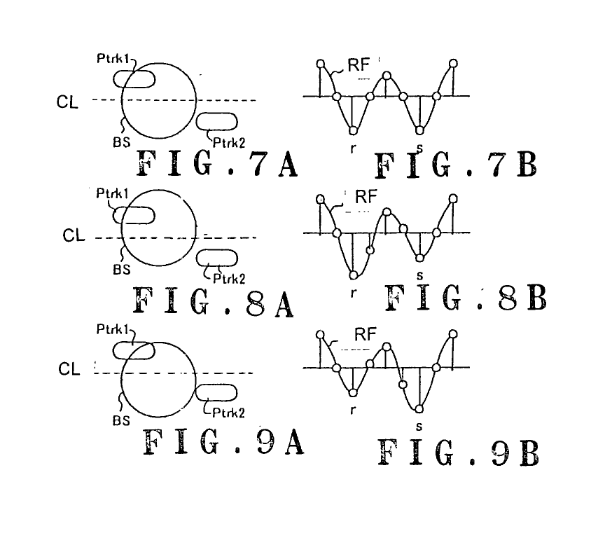

FIG. 6 is a diagram showing an example of internal operation waveforms of the tracking error detector 11.

An example shown in FIG. 6 shows internal operations when the optical head 2 reads from an interval El of the optical disc 3 such as shown in FIG. 2.

In this operation, while the beam spot BS is projected on the tracking pit Ptrk1, the timing generator 9 outputs the timing signal Tr that becomes a logic level “1”at the timing as shown in FIG. 6. Accordingly, the D flip-flop 110 fetches only the sample S₃ from the read sample sequence SS (samples S₁ through S₉) such as shown in FIG. 6, and outputs it as the extracted sample r. Furthermore, the timing generator 9, while the beam spot BS is projected on the tracking pit Ptrk2, outputs the timing signal Ts that becomes a logic level “1”at the timing such as shown in FIG. 6. Accordingly, the D flip-flop 112 fetches only the sample S₇ from the read sample sequence SS such as shown in FIG. 6, and outputs it as the extracted sample s. Accordingly, the subtracter 111 produces a value that is obtained by subtracting the extracted sample s from the extracted sample r, that is, a value of (sample S₃-sample S₇), as the tracking error data TE that expresses a tracking deviation.

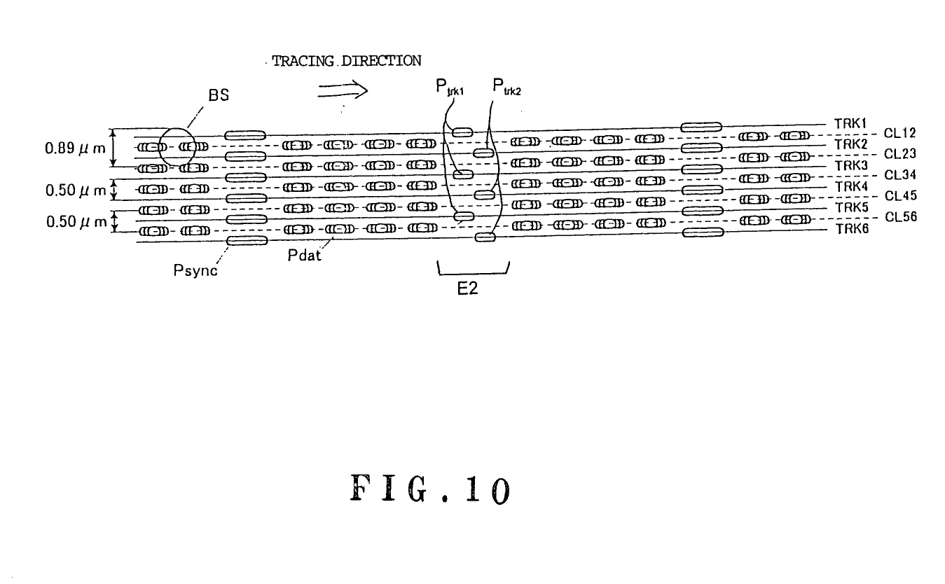

Each pair of FIGS. 7A and 7B through FIGS. 9A and 9B are diagrams showing an area where the beam spot traces nearby the tracking pits and a waveform of the read signal obtained from this area. FIG. 7A shows a tracing state of the beam spot BS when the tracking error does not exist, and each of FIG. 8A and 9A shows that when the tracking error exists.

Firstly, as shown in FIG. 7A, when the beam spot BS is correctly tracing the centerline CL between the tracks, the laser light is evenly irradiated on the tracking pits Ptrk1 and Ptrk2. Accordingly, in this state, as shown in FIG. 7B, the extracted sample r obtained by reading the tracking pit Ptrk1 and the extracted sample r obtained by reading the tracking pit Ptrk2 become the same each other. Accordingly, no tracking error is produced, that is, the tracking error data TE is “0”.

On the other hand, as shown in FIG. 8A, when the beam spot BS is tracing a position deviated toward the tracking pit Ptrk1 side from the centerline CL between the tracks, since the laser light is more irradiated on the tracking pit Ptrk1 than on the tracking pit Ptrk2, a difference develops between amounts of lights reflected from both tracking pits. That is, as shown in FIG. 8B, the extracted sample r obtained by reading the tracking pit Ptrk1 becomes lower than the extracted sample s obtained by reading the tracking pit Ptrk2 by an amount corresponding to the deviation of the tracking with respect to the centerline CL. Accordingly, in this state, a tracking error data TE having a value corresponding to the amount of deviation of the tracking toward the tracking pit Ptrk1 side with respect to the centerline CL is output.

Furthermore, as shown in FIG. 9A, when the beam spot BS is tracing a position deviated toward the tracking pit Ptrk2 side from the centerline CL between the tracks, since more laser light is projected on the tracking pit Ptrk2 than the tracking pit Ptrk1, a difference develops between amounts of lights reflected from both tracking pits. That is, as shown in FIG. 9B, the extracted sample r obtained by reading the tracking pit Ptrk1 becomes higher than the extracted sample s obtained by reading the tracking pit Ptrk2 by an amount corresponding to the deviation of the tracking with respect to the centerline CL. Accordingly, in this case, a tracking error data TE having a value corresponding to an amount of deviation of the tracking toward the tracking pit Ptrk2 side with respect to the centerline CL is output.

Comparing the case where the beam spot traces a portion between the track TRK1 and the track TRK2 with the case where the beam spot traces a portion between the track TRK2 and the track TRK 3, the relationship between a direction of deviation of the beam spot and a polarity of the tracking error is reversed since an arrangement of the tracking pits Ptrk1 and Ptrk2 is reversed. Accordingly, at the tracking error detector 11, the polarity of the tracking error data TE is reversed according to the arrangement of the tracking pits Ptrk1 and Ptrk2.

As explained above, the optical information recording and/or reproducing apparatus shown in FIG. 4 reads each of the tracking pits that are formed at positions deviated from each other in the trace direction on each of tracks adjacent to each other, and obtains the difference of levels of read signals obtained through that process as the tracking error. Then, on the basis of the tracking error, the tracking servo is operated so that the beam spot may trace the centerline between two tracks adjacent to each other. Since this tracking error detection method is high in detection sensitivity, even when the track pitch is narrow, stable and accurate tracking servo can be realized.

In the optical disc shown in FIG. 2 or 3, the tracking pits Ptrk1 and Ptrk2 are apart in the trace direction by a distance nearly equal to a diameter of the beam spot. However, it is not necessarily restricted to this distance. Furthermore, although the tracking pits Ptrk1 and Ptrk2 are disposed after the synchronizing pit Psync, it is not necessarily restricted to this arrangement.

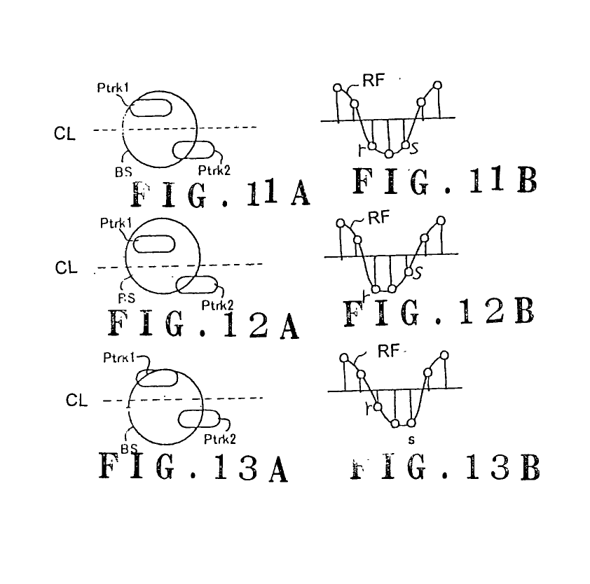

FIG. 10 is a diagram showing a pit pattern of an optical disc according to another embodiment of the present invention that is accomplished in view of such points.

In the optical disc shown in FIG. 10, the tracking pits Ptrk1 and Ptrk2 are arranged closer to each other in the trace direction than those shown in FIG. 2. Accordingly, since an area that the tracking pits occupy on the recording surface becomes smaller, a recording capacity of the information data can be increased. Furthermore, the tracking pits Ptrk1 and Ptrk2 are arranged in a sequence of the data marks Pdat. Since the tracking pits Ptrk1 and Ptrk2 are less susceptible to an intersymbol interference from the synchronizing pits Psync, the tracking servo is more accurately operated.

Each pair of FIG. 11A and 11B through FIG. 13A and 13B are diagrams showing an area where the beam spot traces nearby the tracking pits on an optidal disc according to another embodiment of the present invention and a waveform of the read signal obtained from this area.

FIG. 11A shows a trace state when the beam spot BS is correctly tracing on the centerline CL between the tracks, and FIG. 11B shows a waveform of the read signal RF obtained during this trace state, an extracted sample r and an extracted sample s. Furthermore, FIG. 12A shows the state of tracing when the beam spot BS is tracing a position deviated toward the tracking pit Ptrk1 side from the centerline CL between the tracks. FIG. 12B shows a waveform of the read signal RF obtained during this trace state, an extracted sample r and an extracted sample s. Furthermore, FIG. 13A shows the state of tracing when the beam spot BS is tracing a position deviated toward the tracking pit Ptrk2 side from the centerline CL between the tracks, and FIG. 13B shows a waveform of the read signal RF obtained during this trace state, an extracted sample r and an extracted sample s.

Thus, as a result of the tracking pit Ptrk1 and Ptrk2 being disposed in proximity to each other, as shown in FIG. 11A and 11B through FIG. 13A and 13B, the waveform of the read signal RF has a single peak. Accordingly, the extracted sample r corresponding to a center of the tracking pit Ptrk1 and the extracted sample s corresponding to a center of the tracking pit Ptrk2 appear before and after the peak, and the difference of both levels represents the tracking error. Accordingly, when the tracing position of the beam spot BS is deviated from the centerline between two tracks adjacent to each other, the tracking error corresponding to the amount of the deviation can be obtained.

Although the data marks Pdat are recorded on the centerline CL between two tracks adjacent to each other, in the above embodiments, the data marks may be recorded at positions that are offset by a predetermined distance from the centerline CL. In essence, the data marks Pdat that carry the information data have only to be recorded between two tracks adjacent to each other. In this case, the optical information recording and/or reproducing apparatus controls the tracking servo based on the tracking error signal which takes into account the offset distance from the center line CL.

Furthermore, although in the above embodiments, the data marks Pdat are recorded by use of the phase change recording method, the recording method thereof may be of a magneto-optic recording method. Although a concave synchronizing pit Psync is adopted as the synchronous reference, and concave tracking pits Ptrk1 and Ptrk2 are adopted as the tracking control reference, these marks are not restricted to a particular pit shape. For instance, as the synchronous reference, convex synchronous projection Psync, and as the tracking control reference, convex tracking projections Ptrk1 and Ptrk2 may be adopted. In addition, as marks providing a reference for synchronization and a reference for tracking control, synchronization marks and tracking marks that are recorded by use of a phase change recording or a magneto-optic recording may be adopted, respectively.

Furthermore, even when the present invention is applied to an optical disc in which a film having super resolution effect is deposited on a recording surface and thereby recording densities in a disc tangential direction and disc radial direction are made higher, or an optical disc in which fine marks are recorded on a recording surface by use of a near field light, stable tracking servo can be realized.

As described above, according to the present invention, data marks that carry the information data are recorded between adjacent two tracks on an optical disc of a sampled servo format in which a tracking pit for tracking control and a synchronizing pit for providing a reference for synchronization are formed on the same track.

Accordingly, since the tracking pits do not need to be displaced from each track when a master disc of the optical discs is recorded, there is no need to provide a deflector that deflects a recording laser light. As a result, according to the present invention, an apparatus recording a master disc for optical discs can be realized in a simple structure.

Furthermore, when the information data is recorded to or reproduced from such an optical disc, the optical information recording and/or reproducing apparatus according to the present invention first finds the difference of levels of read signals that are read from each of the tracking pits formed on two tracks adjacent to each other as the tracking error. Then, on the basis of the tracking error, the tracking servo is operated so that the beam spot will trace the centerline between two tracks adjacent to each other. Since such a tracking servo has a high detection accuracy of the tracking error, stable and accurate tracking servo can be realized even when the track pitch is narrow. Accordingly, by making the track pitch narrower, recording density of the optical disc can be made higher and recording capacity can be increased.

This application is based on Japanese Patent application No. 2001-278148 which is herein incorporated by reference.

What is claimed is:

1. A method for recording on an optical disc of a sampled servo format in which a synchronizing pit for providing a reference for synchronization and a tracking pit for providing a reference for tracking are formed on the optical disc in advance, wherein both the synchronizing pit and the tracking pit are formed on the same track of the optical disc and data marks that carries information data are recorded between two tracks that are adjacent to each other.

2. A method for recording on an optical disc of a sampled servo format as set forth in claim 1, wherein the data marks are recorded on a centerline between two tracks that are adjacent to each other.

3. A method for recording on an optical disc of a sampled servo format as set forth in claim 1, wherein the data marks are recorded by using phase-change recording or magneto-optical recording.

4. An optical disc of a sampled servo format in which a synchronizing pit for providing a reference for synchronization and a tracking pit for providing a reference for tracking are formed on the optical disc in advance, wherein both the synchronizing pit and the tracking pit are formed on the same track of the optical disc; and a data marks that carry information data are recorded between two tracks that are adjacent to each other.

5. An optical disc of a sampled servo format as set forth in claim 4, wherein the data marks are recorded on a centerline between two tracks that are adjacent to each other.

6. An optical information recording and/or reproducing apparatus for recording information data on or reproducing the information data from an optical disc of a sampled servo format in which a synchronizing pit for providing a reference for synchronization and a tracking pit for providing a reference for tracking are formed on the optical disc in advance, comprising:
an optical head that irradiates a laser light between tracks including two tracks that are adjacent to each other on the optical disc, reads recorded information from the optical disc, obtains a read signal, and records data marks that carry information data between the tracks;
a component for extracting, from the read signal, a value corresponding to the tracking pit formed on one of the two tracks that are adjacent to each other as a first extracted sample, and a value corresponding to the tracking pit formed on the other one of the two tracks that are adjacent to each other as a second extracted sample;
a component for obtaining a difference value between the first extracted sample and the second extracted sample as a tracking error signal; and
a driving component for controlling a position of a beam spot of the laser light according to the tracking error signal so that the beam spot traces a portion between the two tracks that are adjacent to each other.

7. An optical information recording and/or reproducing apparatus as set forth in claim 6, wherein the driving component controls the position of the beam spot of the laser light according to the tracking error signal so that the beam spot traces a centerline between the two tracks that are adjacent to each other.

8. An optical information recording and/or reproducing apparatus as set forth in claim 6, wherein the data marks are recorded by use of a phase-change recording or a magneto-optical recording.
